(19) United States
(12) Patent Application Publication
(10) Pub. No.: US 2011/0164622 A1
(43) Pub. Date: Jul. 7, 2011

(54) OPERATION AND CONSTRUCTION METHOD OF NETWORK USING MULTI-RATE INTERFACE PANEL

(76) Inventors: Yukihisa TAMURA, Yokohama (JP); Manabu Makino, Yokohama (JP); Koji Takatori, Tokyo (JP); Hiromi Murakami, Yokohama (JP); Yoshimasa Kusano, Kawasaki (JP); Toshiyuki Atsumi, Yokohama (JP); Masatoshi Shibasaki, Yokohama (JP)

(21) Appl. No.: 13/052,275

(22) Filed: Mar. 21, 2011

Related U.S. Application Data
(63) Continuation of application No. 12/073,593, filed on Mar. 7, 2008.
Application No. 12/073,593 is a continuation-in-part of application No. 12/028,054, filed on Feb. 8, 2008.

(30) Foreign Application Priority Data
Mar. 14, 2007 (JP) 2007-064339
Apr. 2, 2007 (JP) 2007-096007

(51) Int. Cl. H04L 12/66

(52) U.S. Cl. 370/463

(57) ABSTRACT

An interface unit for processing a first signal and a second signal, the second signal set to different transmission rate from the first signal and/or a different signal type from the first signal, including a plurality of interface panels, each of the plurality of interface panels including: a storage device which stores a first logic circuit data corresponding to the first signal and a second logic circuit data corresponding to the second signal, a configuration function unit which controls to select the first logic circuit data or the second logic circuit data, and a programmable logic circuit which reconfigures the first logic circuit data or the second logic circuit data based on a selection by the configuration function unit.

### CROSS-REFERENCE TO RELATED APPLICATIONS

This application is a continuation of application Ser. No. 12/073,593, filed Mar. 7, 2008, which is a continuation-in-part of and claims priority to T. Atsumi et al., U.S. patent application Ser. No. 12/028,054, filed Feb. 8, 2008, entitled “MULTIPLEXED OPTICAL SIGNAL TRANSMISSION APPARATUS” (the “first related application”), which is commonly assigned herewith, the contents of all of which are incorporated herein by reference, and with priority claimed for all commonly disclosed subject matter.

### INCORPORATION BY REFERENCE

The present application claims priority from Japanese applications JP-2007-064339 filed on Mar. 14, 2007 and JP-2007-096007 filed on Apr. 2, 2007 the contents of which are hereby incorporated by reference into this application.

### BACKGROUND OF THE INVENTION

The present invention relates to a network having excellent operability using interface panels capable of processing a variety of signal types in a network handling a number of signal types, and to a method of configuring a network capable of flexible handling of service addition/change and system failure.

High speed and large capacity of a network typically the Internet have been required because of an increase in traffics. To solve this, an optical network typically representing a Wavelength Division Multiplexing (WDM) scheme has prevailed rapidly. WDM is a scheme for multiplexing optical signals having different wavelengths in a single optical fiber, and can realize large capacity communications easily by increasing the number of wavelengths to be multiplexed, without installing a new optical fiber network. In recent years, not only large capacity communications but also flexible and versatile functions have been required such as a network capable of branching/inserting a desired wavelength at an intermediate node and a network capable of routing an optical signal without converting the optical signal into an electric signal. The former network uses an Optical Add Drop Multiplexer (OADM), and the latter network uses an Optical Cross Connect (OXC).

Recently, a variety of signals in different application fields are connected to a network. These signal types include: Ethernet (registered trademark) which is standardized by IEEE802.3 and is the main trend of Local Area Network (LAN); Synchronous Digital Hierarchy/Synchronous Optical Network (SDH/SONET) which is standardized by ANSI T1.105 and is the main trend of Wide Area Network (WAN); Fiber Channel which is standardized by The American National Standards Institute T11 technical committee (ANSI T11) and is the main trend of Storage Area Network (SAN); and the like. FIG. 1 shows a list of signals connected to a network. As shown in FIG. 1, there are a huge number of signal types connected to an optical network, and a transmission rate is a broadband from 50 Mbps to 40 Gbps.

Since a number of signals are used in a network as described above, if a monitoring and controlling method different for each signal is used, it is obvious that maintenance becomes complicated. It has been desired to use a network management method independent from a signal type. A typical method solving this requirement may be an Optical Transport Network (OTN) standardized by ITU-T G.709. An Optical Channel (Och) of OTN can be mapped independently from a signal type so that it is possible to perform collective monitoring and controlling of the whole network. Long distance transmission becomes possible by adopting Forward Error Correction (FEC) technologies utilized by music and video media for error correction code. Standardized OTNs include OTU1 at 2.5 Gbps, OTU2 at 10 Gbps and OTU3 at 40 Gbps, and a plurality of low speed signals lower than 2.5 Gbps are multiplexed to be connected to OTN.

FIG. 2 shows an example of the configuration of a network utilizing OTN. Signals shown in FIG. 1 are output from client apparatus units 1-1 to 1-n (11-1 to 11-n), client apparatus units 2-1 to 2-n (12-1 to 12-n) and client apparatus units 3-1 to 3-n (13-1 to 13-n), and switched to be loaded on an Och frame at an interface function unit 1 (10-1), an interface function unit 2 (10-2) and an interface function unit 3 (10-3), respectively.

FIG. 3 shows the detailed structure of an interface function unit. An interface function unit (10) is constituted of an EFC function unit (20), an SW unit (30) for selecting a line route, and a monitoring and controlling unit (40) for monitoring a signal quality at the FEC function unit and controlling a route at the SW unit. In accordance with a control signal from an upper level controller (50) such as Operation System (OpS), the monitoring and controlling unit (40) controls the interface function unit (10). The FEC unit (20) is constituted of interface panels to switch a signal from each of the client apparatus units (14-1 to 14-n) to be loaded in the Och frame. In the example shown in FIG. 3, connected to the FEC function unit are the client apparatus units (14-1 to 14-n) using OC-192 of SONET, STM-16 of SDH, and 10 GBASE-LR of 10 GbE (registered trademark). An interface panel having a fixed rate corresponding to each signal is disposed in the FEC function unit (20). A signal processed in the FEC function unit changes its name to OTU2 for a 10 Gbps class, OUT1 for a 2.5 Gbps class, and 10 GbE LAN-PHY over OTN for 10 GBASE-LR.

Interface panels are classified roughly into two types depending upon their functions. One is a transponder panel which is disposed at the border of the OTN optical transport network, switches a signal to be loaded on the Och frame, and corresponds to the interface panel shown in FIG. 3. The other is a regenerative repeater panel for 3R regenerative repeating of an optical signal. The 3R regenerative repeating is a function of performing Reshaping, Retiming and Regeneration of an optical signal. FIG. 4 shows the structure that regenerative repeater panels are used in the interface function unit. As compared to FIG. 3, this structure omits the SW unit (30). If the route change is required in the OTN optical transport network, the SW unit may be provided at the front or back end of the regenerative repeater panel. The interface function units shown in FIGS. 3 and 4 are basic elements constituting a network, and a combination thereof can configure a desired network such as OADM and OXC.

As shown in FIGS. 3 and 4, a conventional interface panel has a fixed rate, and one panel is required to process one type of signal. This means that it is necessary to prepare types of the interface panel as many as the number of client apparatus connected to the interface function unit. As the number of components increases, maintenance and operation become complicated and the cost of the whole network increases. When the network configuration is to be changed, replacement works for interface panels are required so that accidental service change and addition cannot be dealt quickly. In order to meet traffic needs anticipated to increase more and more in the near future, a network configuration has been desired earnestly which can solve these issues and operate flexibly.

### SUMMARY OF THE INVENTION

As described in the prior art, a network can be managed collectively by adopting an OTN optical transport network. However, since a conventional interface panel has a fixed rate, the whole network has a difficulty in terms of management and cost. Component replacement works by maintainers occur when the network configuration is to be changed, and it takes time to resume operations of lines. When new services are to be added, lines cannot be newly added usually until signal types to be used for the services are determined.

If a network is to be supplied with a redundancy structure, it is necessary to configure reserved lines as many as the number of signals under operation so that the numbers of optical fiber lines and interface panels are simply doubled. If an already existing optical fiber network runs down, it is necessary to install a new network, resulting in an increase in cost of facilities and poor maintenance of reserved lines.

The present invention provides a method of realizing a network capable of reducing the number of components and providing inexpensive and simple maintenance management, by using an interface panel compatible with a multi-rate.

The present invention further provides a method of configuring reserved lines considering economy of an optical fiber network.

In order to solve the above-described issues, the present invention adopts a multi-rate compatible interface panel utilizing a programmable logic circuit unit capable of being reconfigured. A signal from a client apparatus is processed by a programmable logic circuit such as a Field Programmable Gate Array (FPGA) mounted on the interface panel. The mounted programmable logic circuit determines unanimously which signal is to be processed. In order to realize a multi-rate by a conventional method, it is necessary to mount programmable logic circuits as many as the number of signals to be processed, resulting in an increase in hardware scale.

According to the present invention, a multi-rate is realized by applying a programmable logic circuit structure such as shown in FIG. 5 to the interface panel. The feature of the present invention resides in that a plurality of pieces of logic circuit data are stored in a storage device (71). The programmable logic circuit structure shown in FIG. 5 is constituted of a configuration function unit (70) for controlling reconfiguration of a logic circuit, the storage device (71) for storing a plurality of pieces of logic circuit data (72-1 to 72-n) and the programmable logic circuit (73) for processing signals. For reconfiguration of the programmable logic circuit (73), when a configuration start signal from an upper level controller is received, the configuration function unit (70) sends a logic circuit select signal to the storage device (71), and the storage device (71) sends desired logic circuit data to the programmable logic circuit (73) to realize reconfiguration. Upon completion of reconfiguration, the programmable logic circuit (73) returns a configuration completion signal to the upper level controller.

According to reconfiguration techniques adopted by the present invention, an interface panel is made compatible with a multi-rate without increasing the circuit scale. It is therefore possible to realize a multi-rate compatible interface panel which is inexpensive and compact and has a reduced number of components.

According to the present invention, a multi-rate compatible interface panel is adopted in a network using a variety of signals. It is therefore possible to provide a network with a reduced number of components and easy management. In addition, since the interface panel can change a signal type to be processed, by using only an operation from an upper level controller, a replacement work for the interface panel can be omitted when the network configuration is required to be changed abruptly.

It is possible not only to configure reserved lines considering economy of an optical fiber network but also to realize quick line recovery by an operation from an upper level controller when failure occurs.

Other objects, features and advantages of the invention will become apparent from the following description of the embodiments of the invention taken in conjunction with accompanying drawings.

### BRIEF DESCRIPTION OF THE DRAWINGS

FIG. 1 shows a list of signal types connected to a network according to the present invention.

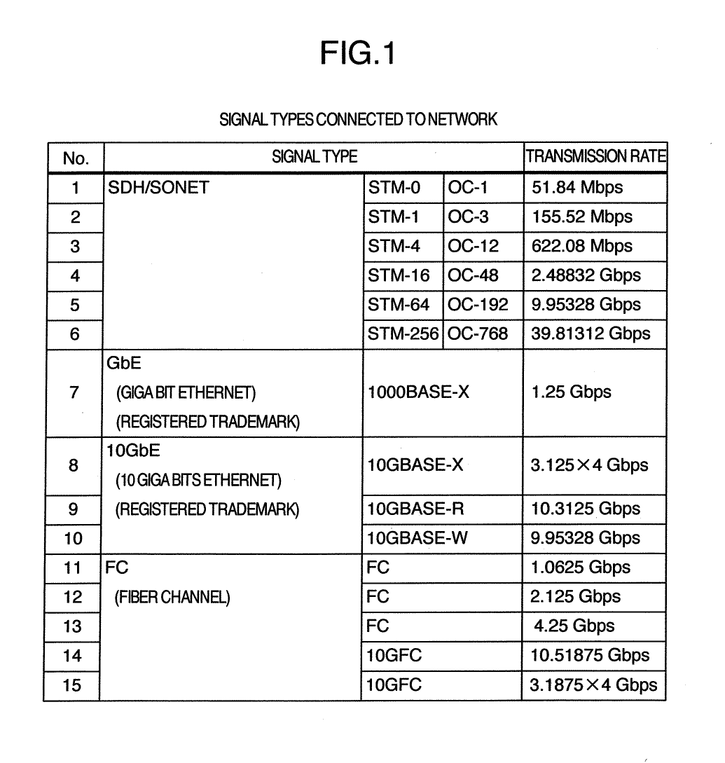

FIG. 2 is an illustrating diagram showing an example of a network configuration utilizing OTN which the present invention adopts.

FIG. 3 is an illustrative diagram showing a conventional structure of an interface function unit which the present invention adopts.

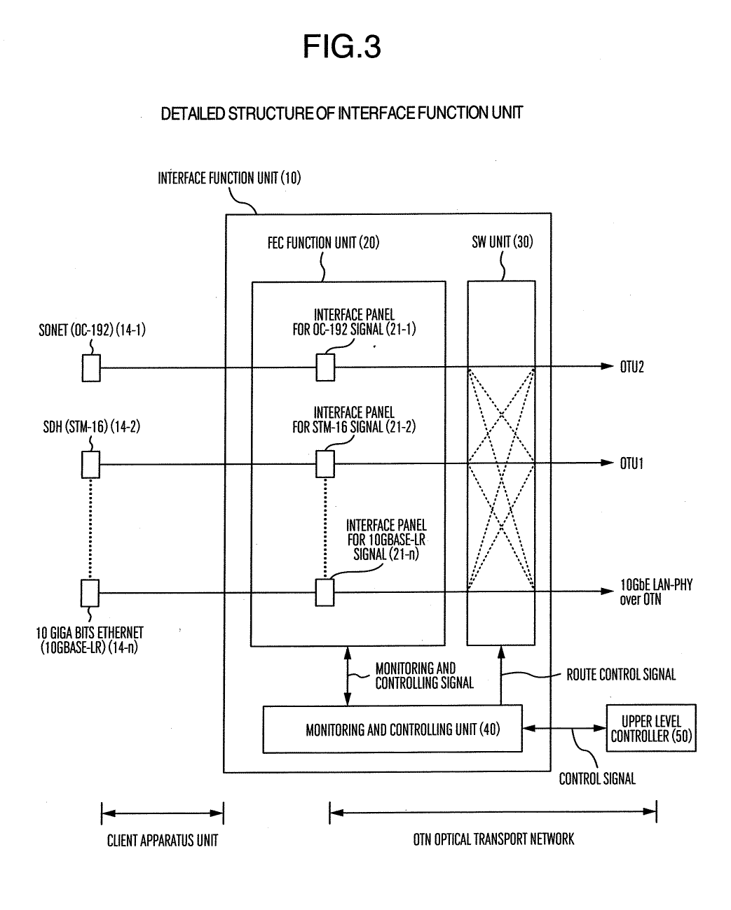

FIG. 4 is an illustrative diagram showing a conventional structure of the interface function unit utilizing a 3R regenerative repeater which the present invention adopts.

FIG. 5 is a block diagram of a programmable logic circuit structure capable of reconfiguration to which the present invention adopts.

FIG. 6 is an illustrating diagram of an interface function unit utilizing multi-rate compatible transponder panels according to an embodiment of the present invention.

FIG. 7 is an illustrative diagram showing a network configuration utilizing multi-rate compatible transponder panels according to the embodiment of the present invention.

FIG. 8 is an illustrative diagram showing a line setting procedure for the network configuration utilizing multi-rate compatible transponder panels according to the embodiment of the present invention.

FIG. 9 is an illustrative diagram showing a line changing procedure for the network configuration utilizing multi-rate compatible transponder panels according to the embodiment of the present invention

FIG. 10 is an illustrative diagram showing an interface function unit applying a multi-rate compatible transponder panel to a 3R regenerative repeater according to an embodiment of the present invention.

FIG. 11 is an illustrative diagram showing the redundancy structure of a network utilizing a multi-rate compatible regenerative repeater panel according to the embodiment of the present invention.

FIG. 12 is an illustrative diagram showing a reserved line setting procedure for a network configuration utilizing multi-rate compatible regenerative repeater panels according to the embodiment of the present invention.

### DETAILED DESCRIPTION OF THE INVENTION

Typical two embodiments of the present invention will now be described with reference to the accompanying drawings.

In the first embodiment, description will be made on a network configuration utilizing multi-rate compatible transponder panels.

In the second embodiment, description will be made on a method of configuring a reserved line utilizing a multi-rate compatible regenerative repeater panel.

### First Embodiment

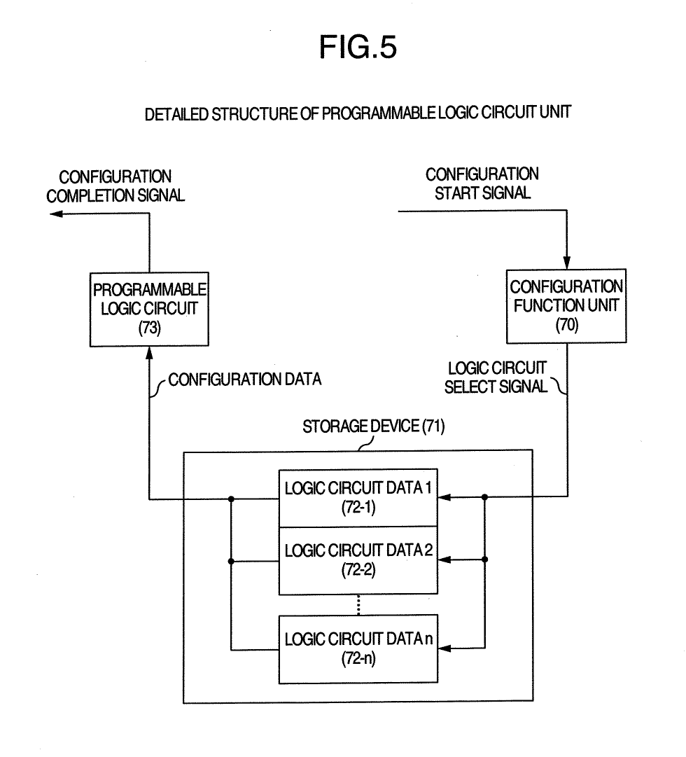

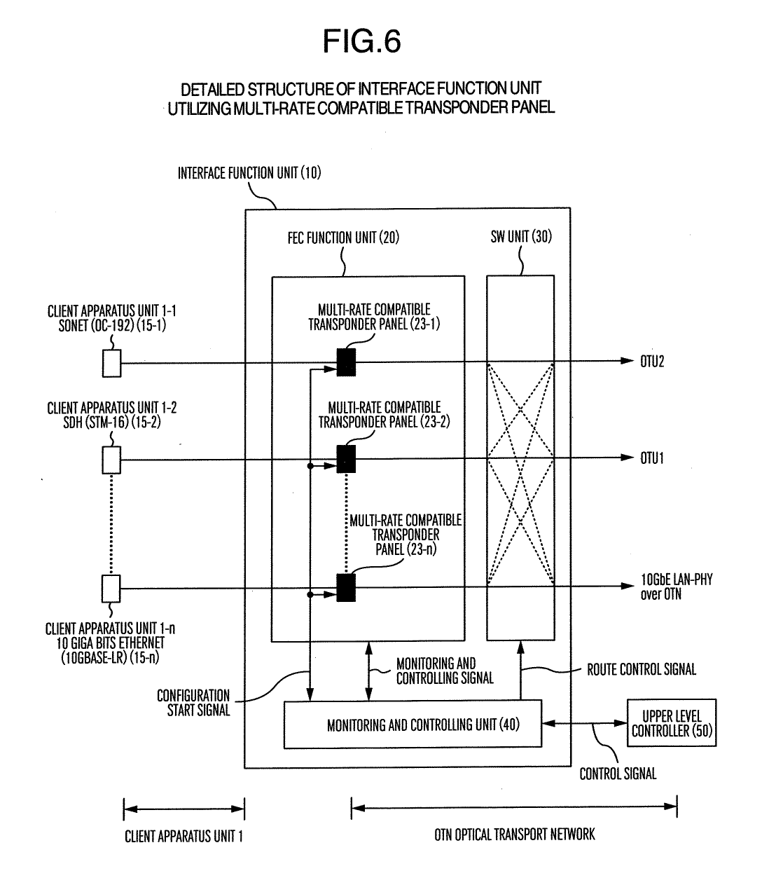

In the first embodiment, description will be made on a network configuration applying a multi-rate compatible transponder panel to an interface function unit. FIG. 6 shows the detailed structure of the interface function unit. In this structure, all of the interface panels (21-1 to 21-n) having a fixed rate are replaced with multi-rate compatible transponder panels (23-1 to 23-n). An upper level controller (50) sends a configuration start signal to the multi-rate compatible transponder panels (23-1 to 23-n). Upon reception of the configuration start signal, the multi-rate compatible transponder panels (23-1 to 23-n) realize configuration described with reference to FIG. 5.

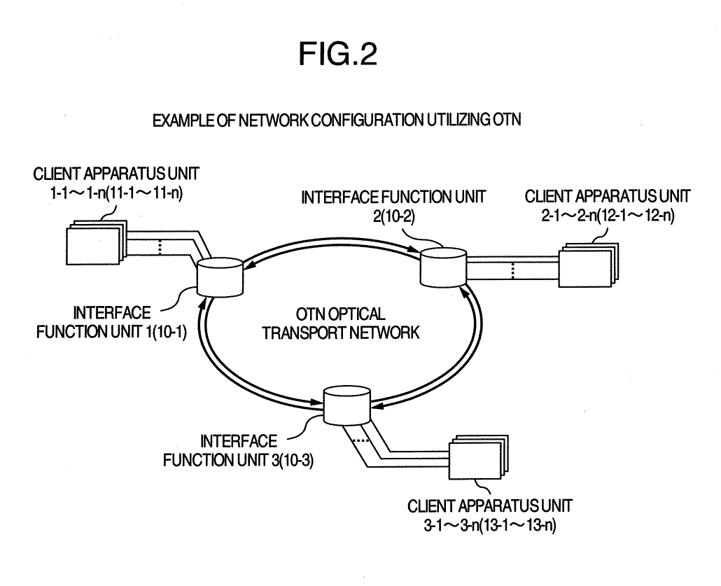

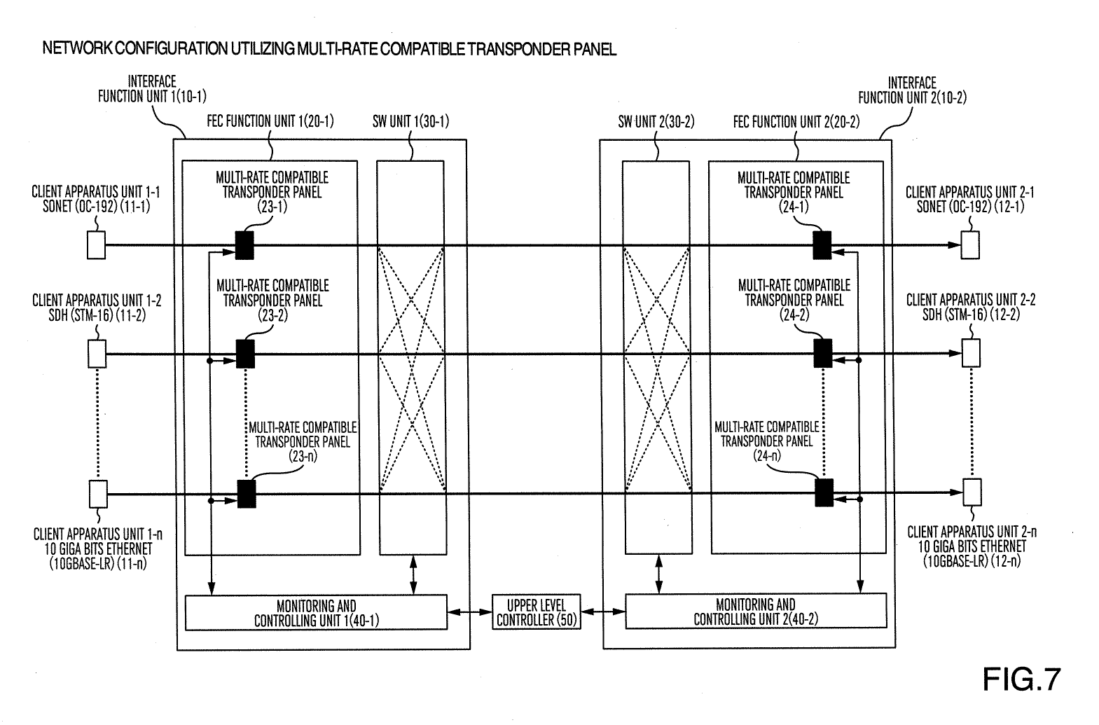

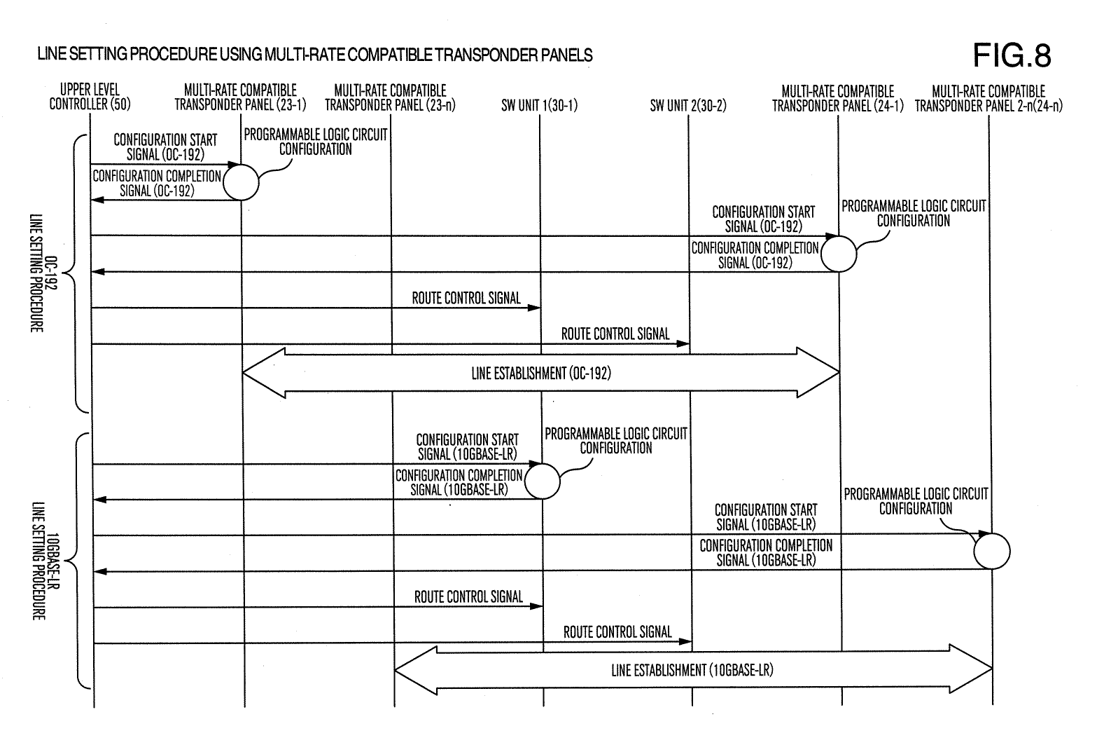

FIG. 7 shows by way of example a section between the client apparatus units 1-1 to 1-n (11-1 to 11-n) and client apparatus units 2-1 to 2-n (12-1 to 12-n) shown in FIG. 2, in an embodiment wherein multi-rate compatible transponder panels are applied to an actual network. FIG. 8 illustrates a pass setting procedure for the network shown in FIG. 7, in which pass are set by OC-192 in the section between the client apparatus unit 1-1 (11-1) and client apparatus unit 2-1 (12-1) and by 10 GBASE-LR in the section between the client apparatus unit 1-n (11-n) and client apparatus unit 2-n (12-n), by way of example.

In the pass establishment procedure for OC-192, upon reception of a configuration start signal for OC-192 sent from the upper level controller (50), the multi-rate compatible transponder panel 1-1 (23-1) and multi-rate compatible transponder panel 2-1 (24-1) configure the programmable logic circuits so as to make them match a circuit structure for OC-192 signal processing. After completion of configuration, a configuration completion signal is returned to the upper level controller (50). Upon reception of the configuration completion signal, the upper level controller (50) sends a route control signal to the SW unit 1 (30-1) and SW unit 2 (30-2) to thereby determine a route of a pass and establish a pass of OC-192 in the section between the client apparatus unit 1-1 (23-1) and client apparatus unit 2-1 (24-1).

A pass for 10 GBASE-LR in the section between the client apparatus unit 1-n (23-n) and client apparatus unit 2-n (24-n) is established in the manner similar to the pass setting procedure for OC-192.

As described above, the multi-rate compatible transponder panel can be changed to have a function corresponding to the transponder panel having a desired fixed rate, only by an operation of the upper level controller. It is therefore possible to reduce the number of types of components of the whole network.

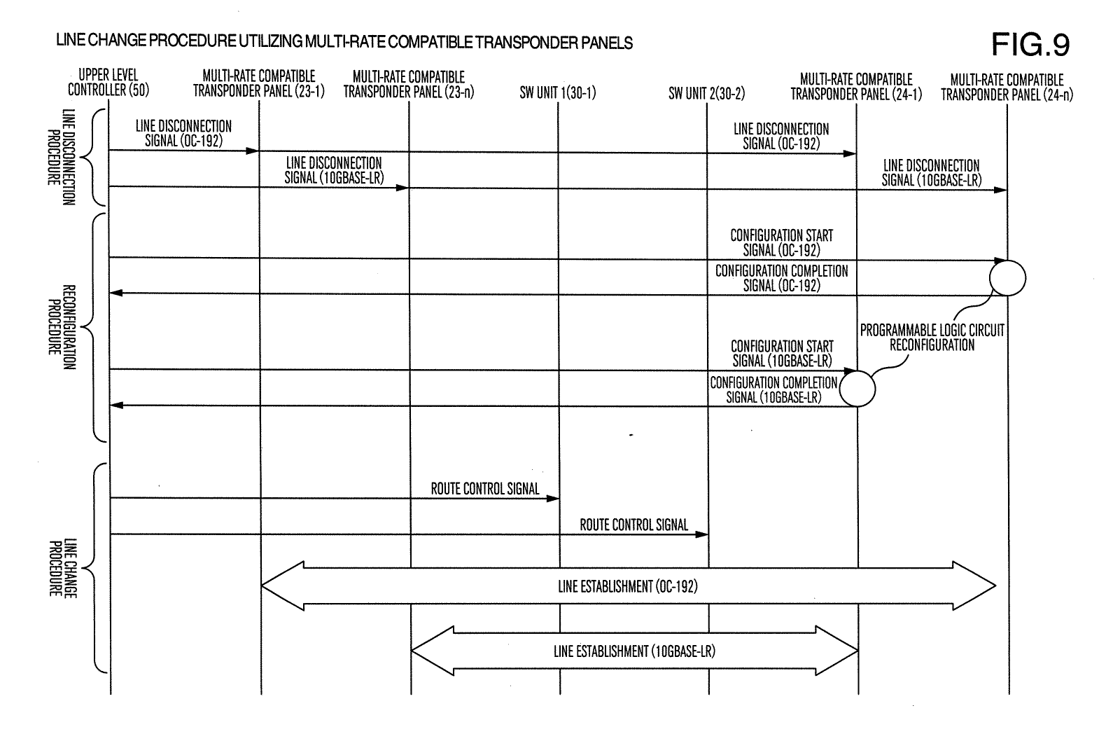

Next, description will be described on a pass change procedure utilizing multi-rate compatible transponder panels. FIG. 9 illustrates a route change procedure for the passes established in FIG. 8, in which the section between the client apparatus unit 1-1 (11-1) and client apparatus unit 2-n (12-n) is changed to OC-192 and the section between the client apparatus unit 1-n (11-n) and client apparatus unit 2-1 (12-1) is changed to 10BASE-LR.

In the pass change procedure, the upper level controller (50) sends a pass disconnection signal to each multi-rate compatible transponder panel, confirms a pass disconnection, and thereafter sends a configuration start signal for the logic circuit for OC-192 signal processing to the multi-rate compatible transponder panel 2-n (12-n) and a configuration start signal for the logic circuit for 10BASE-LR signal processing to the multi-rate compatible transponder panel 2-1 (12-1), to thereby conduct reconfiguration. Upon reception of the configuration completion signals, the upper level controller (50) sends a route control signal to the SW unit 1 (30-1) and SE unit 2 (30-2) to conduct route control and complete the pass change.

As described above, the pass change can be made only by reconfiguration control and route change control at SW units by the upper level controller. It is therefore unnecessary for a maintainer to manually exchange transponder panels, and quick pass change can be made.

### Second Embodiment

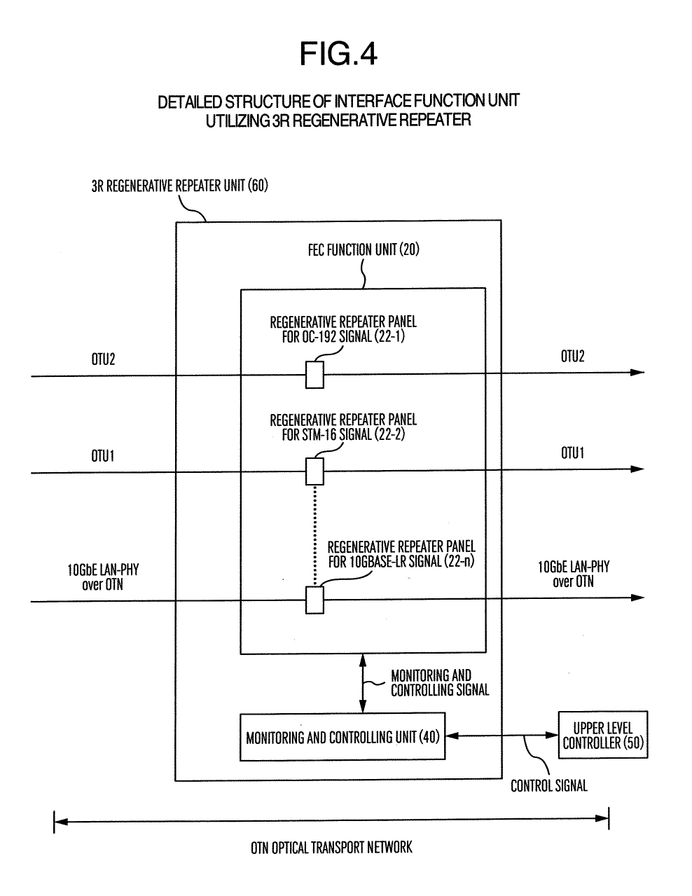

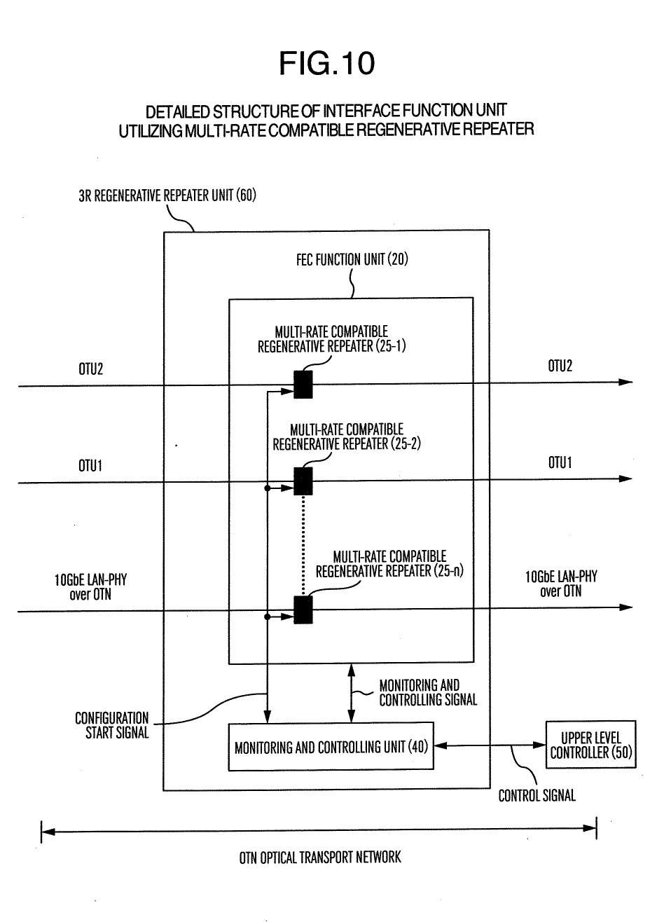

In the second embodiment, description will be made on a method of configuring a reserved line adopting a multi-rate compatible regenerative repeater panel. FIG. 10 shows the detailed structure of the interface function unit adopting multi-rate regenerative repeater panels, in which all the regenerative repeater panels (22-1 to 22-n) of the FEC function unit (20) shown in FIG. 4 are replaced with multi-rate compatible regenerative repeater panels (25-1 to 25-n). The upper level controller (50) sends a configuration state signal to the multi-rate compatible repeater panels to conduct configuration described with reference to FIG. 5.

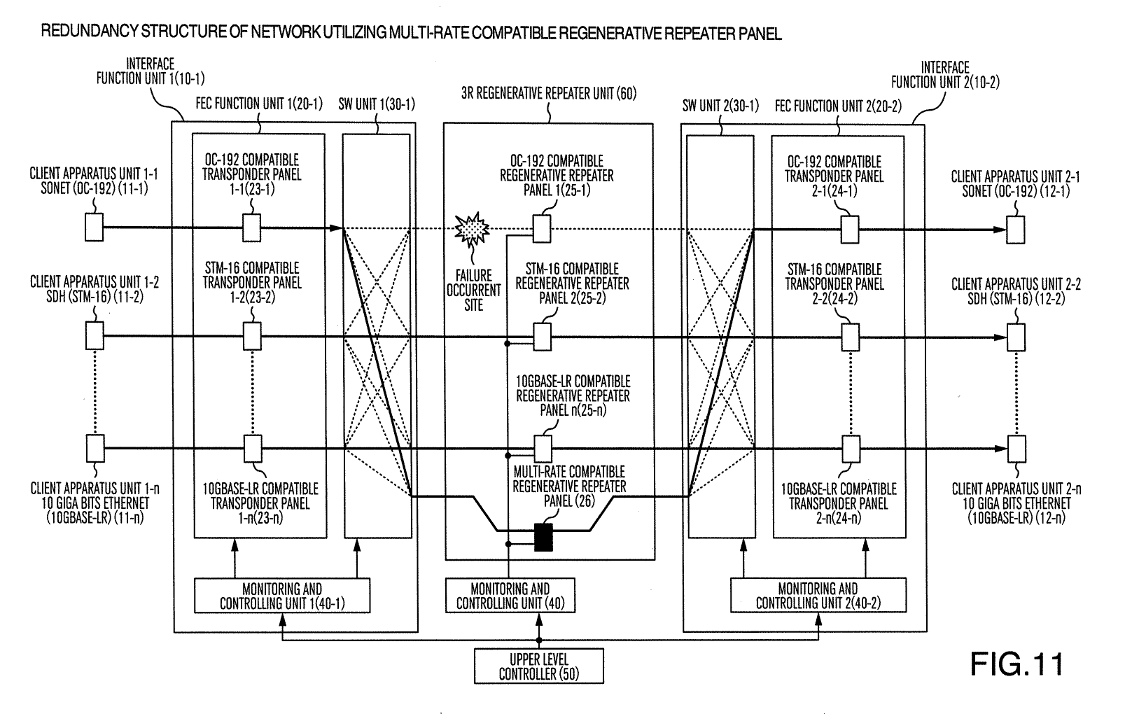

FIG. 11 shows an embodiment applying a multi-rate compatible regenerative repeater panel to an actual network, in which a 3R regenerative repeater unit is disposed in a section between the client apparatus units 1-1 to 1-n (11-1 to 11-n) and client apparatus units 2-1 to 2-n (12-1 to 12-n) shown in FIG. 2, by way of example. One reserved line is provided in FIG. 11, and only the reserved line is provided with a multi-rate compatible regenerative repeater panel (26).

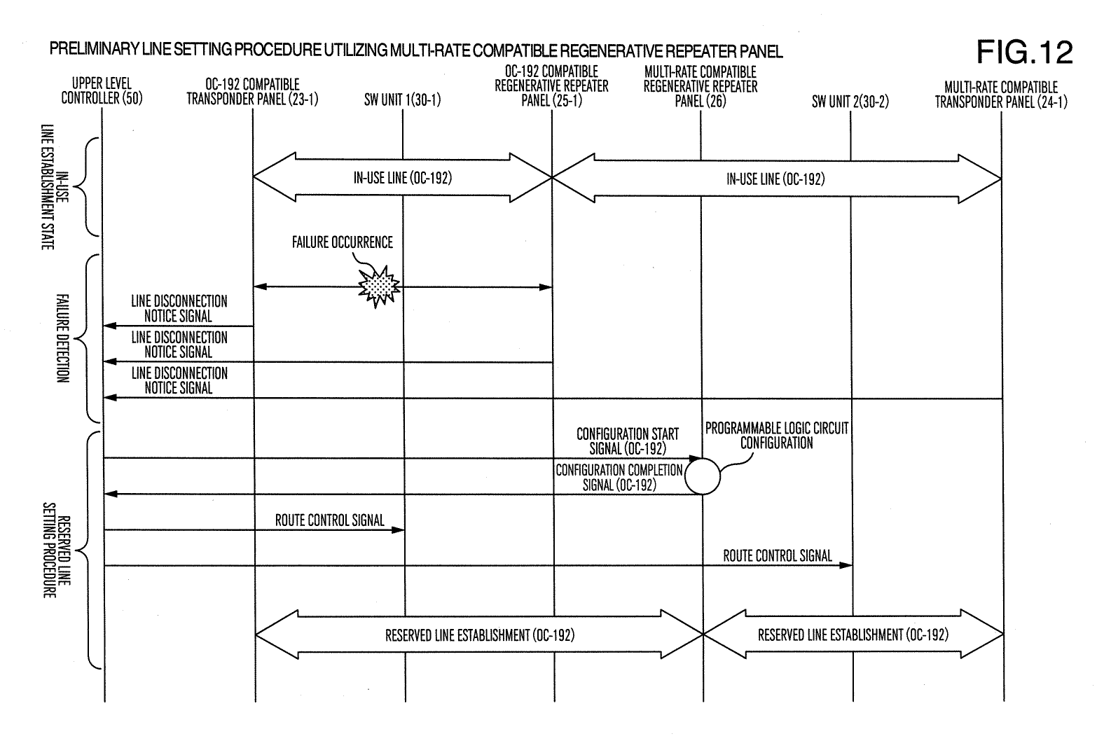

FIG. 12 illustrates a setting procedure for the reserved line shown in FIG. 10. Description will be made on an illustrative case in which failure occurs in an OC-192 line section between the client apparatus unit 1-11 (11-1) and client apparatus unit 2-1 (12-1). When failure occurs, the interface panel in the failure occurrence section sends a pass disconnection notice signal to the upper level controller (50). Upon reception of the pass disconnection notice signal, the upper level controller identifies the signal type in the failure section, and sends a configuration start signal for the failure occurrence section signal type to the multi-rate compatible regenerative repeater panel (26) of the reserved line. In the example shown in FIG. 12, configuration is performed for the logic circuit for OC-192 signal processing. Upon reception of a configuration completion signal from the multi-rate compatible regenerative repeater panel (26), the upper level controller (50) sends a route control signal to the SW unit 1 (30-1) and SW unit 2 (30-2) to thereby change the route to the reserved line and recover the OC-192 line.

As described above, by using a multi-rate compatible regenerative repeater panel, a line in a failure section can be switched to a reserved line at once without component replacement works. Since it is not necessary to provide reserved lines as many as the number of signals connected to a network, a redundance structure effectively using a limited resource of an optical fiber network can be provided. Since the reserved lines can be reduced, management processes for reserved lines can be minimized. Although only one reserved line is provided in the structure shown in FIG. 11, the number of reserved lines may be increased in a network section having a number of lines to reinforce redundancy.

As various signal types are connected to a network, the number of components constituting the network increases. There is therefore a fear that not only operability of a maintainer is degraded but also an investment cost of facilities becomes enormous.

To solve these issues, the means for changing signal type to be processed by an interface panel by using only an operation by an upper level controller can flexibly change the configuration of a network which is anticipated to become complicated more and more. It is considered that the use value of the present invention is considerably high.

It should be further understood by those skilled in the art that although the foregoing description has been on embodiments of the invention, the invention is not limited thereto and various changes and modifications may be made without departing from the spirit of the invention and the scope of the appended claims.

What is claimed is:

1. An interface unit for processing a first signal and a second signal, the second signal set to a different transmission rate from the first signal and/or a different signal type from the first signal, the interface unit including a plurality of interface panels, each interface panel of the plurality of interface panels comprising:
a storage device which stores a first logic circuit data corresponding to the first signal and a second logic circuit data corresponding to the second signal,
a configuration function unit which controls to select the first logic circuit data or the second logic circuit data, and
a programmable logic circuit which reconfigures the first logic circuit data or the second logic circuit data, based on a selection by the configuration function unit.

2. The interface unit according to claim 1, wherein a first interface panel among the plurality of interface panels processes the first signal, and wherein a second interface panel among the plurality of interface panels processes the second signal.

3. The interface unit according to claim 1, wherein the configuration function unit controls to select the first logic circuit data or the second logic circuit data, based on a receipt of a configuration start signal.

4. The interface unit according to claim 3, wherein the configuration start signal is originated from an external controller.

5. The interface unit according to claim 1, further comprising:
a switching unit coupled to the plurality of interface panels, and
a controlling unit coupled to the plurality of interface panels and the switching unit.

6. The interface unit according to claim 1, wherein the programmable logic circuit originates a configuration completion signal upon a configuration by the programmable logic circuit.

7. The interface unit according to claim 6, wherein the programmable logic circuit sends the configuration completion signal to an external controller.

8. The interface unit according to claim 1, further comprising a switching unit coupled to the plurality of interface panels, wherein the switching unit receives a route control signal after a reconfiguration by the programmable logic circuit.

9. A system for processing a first signal and a second signal, the second signal set to a different transmission rate from the first signal and/or a different signal type from the first signal, the system comprising:
a first interface unit including a plurality of first interface panels and a first switching unit,
a second interface unit including a plurality of second interface panels and a second switching unit, and
a controller coupled to the first interface unit and the second interface unit,
wherein each of the plurality of first interface panels including:
a first storage device which stores a first logic circuit data corresponding to the first signal and a second logic circuit data corresponding to the second signal,
a first configuration function unit which controls to select the first logic circuit data or the second logic circuit data, and
a first programmable logic circuit which reconfigures the first logic circuit data or the second logic circuit data based on a selection by the first configuration function unit,
wherein each of the plurality of second interface panels including:
a second storage device which stores a first logic circuit data corresponding to the first signal and a second logic circuit data corresponding to the second signal,
a second configuration function unit which controls to select the first logic circuit data or the second logic circuit data, and
a second programmable logic circuit which reconfigures the first logic circuit data or the second logic circuit data based on a selection by the second configuration function unit,
wherein the controller is coupled to control at least one of the first switching unit, the second switching unit, the first configuration function unit, and the second configuration function unit.

10. The system according to claim 9, wherein the first configuration function unit controls to select the first logic circuit data or the second logic circuit data based on a configuration start signal sent by the controller.

11. The system according to claim 9, wherein the first programmable logic circuit sends a configuration completion signal to the controller in case that the first programmable logic circuit completes configuration.

12. The system according to claim 11, wherein the controller sends a route control signal to the first switching unit and the second switching unit, in case that the controller receives the configuration completion signal.

13. The system according to claim 11, wherein the controller sends a route control signal to the first switching unit and the second switching unit, in case that the controller receives the configuration completion signal to configure a pass of the first signal or the second signal.

14. The system according to claim 11, wherein the controller sends a route control signal to the first switching unit and the second switching unit, in case that the controller receives the configuration completion signal to configure a pass between one of the first interface panels selecting the first logic circuit data and one of the second interface panels selecting the first logic circuit data.
